(19) United States
(12) Patent Application Publication
(10) Pub. No.: US 2025/0362695 A1
(43) Pub. Date: Nov. 27, 2025

(54) METHOD FOR DETECTING TEMPERATURE CONTROL SYSTEM, TEMPERATURE CONTROL SYSTEM, COMPUTER DEVICE, AND STORAGE MEDIUM

(71) Applicant: GeneMind Biosciences Co., Ltd., Shenzhen (CN)

(72) Inventors: Yu Rao, Shenzhen (CN); Lingzhi Zhou, Shenzhen (CN)

(21) Appl. No.: 19/210,235

(22) Filed: May 16, 2025

(30) Foreign Application Priority Data
May 22, 2024 (CN) 202410645715.6

(51) Int. Cl. G05D 23/19; B01L 7/00

(52) U.S. Cl. CPC G05D 23/1917; B01L 7/00; B01L 2300/185; B01L 2300/1894

(57) ABSTRACT

Disclosed are a method for detecting a temperature control system, the temperature control system, a computer device, and a storage medium. The temperature control system includes a temperature control assembly and a cooling assembly, the temperature control assembly being configured for controlling a temperature of a temperature control target, and the cooling assembly being configured for performing liquid-based heat dissipation on heat generated by the temperature control assembly, and the method includes: acquiring a liquid pressure in the cooling assembly; acquiring the temperature of the temperature control target; and determining whether the temperature control system fails or not according to the liquid pressure and the temperature of the temperature control target. Therefore, whether the temperature control system fails or not is determined based on the liquid pressure of the cooling assembly and the temperature of the temperature control target, and the temperature control system can be monitored to meet the requirement of the temperature control target on the required temperature; meanwhile, the temperature anomaly of the temperature control target caused by the reduction of the temperature control efficiency due to the failure of the temperature control system can be prevented.

### TECHNICAL FIELD

The present disclosure relates to the field of gene sequencing, and in particular, to a method for detecting a temperature control system, the temperature control system, a computer device, and a storage medium.

### BACKGROUND

Gene sequencing technology refers to the technical means of acquiring the base sequence of DNA or RNA by assays. The current dominant sequencing technology is high-throughput sequencing. In a sequencing platform that achieves high-throughput sequencing based on sequencing by synthesis, the general gene sequencing process includes: fixing a nucleic acid sample under test on a flow cell, for example, by hybridization; forming a nucleic acid molecule cluster on the nucleic acid sample under test by using PCR amplification; adding sequencing reagents (e.g., bases with a fluorophore, a polymerase, a primer, and the like) to the flow cell; bonding the bases with the fluorophore to the base on the nucleic acid sample under test according to the base complementary pairing principle; exciting the fluorophore by an optical imaging system to generate fluorescence; collecting the fluorescence for forming an image; and performing base calling on the image, so as to achieve base sequence determination of the nucleic acid sample under test.

In the gene sequencing process, a water-based heat dissipation system of the sequencer can heat up and cool down the flow cell so as to meet the temperature required by biochemical reaction in the flow cell. In the related art, the sequencer cannot monitor the water-based heat dissipation system, and if the water-based heat dissipation system fails, users cannot normally operate the sequencer for sequencing.

### SUMMARY

The present disclosure provides a method for detecting a temperature control system, the temperature control system, a computer device, and a storage medium.

Provided in the embodiments of the present application is a method for detecting a temperature control system, where the temperature control system includes a temperature control assembly and a cooling assembly, the temperature control assembly being configured for controlling a temperature of a temperature control target, and the cooling assembly being configured for performing liquid-based heat dissipation on heat generated by the temperature control assembly, and the method includes:
acquiring a liquid pressure in the cooling assembly;
acquiring the temperature of the temperature control target; and
determining whether the temperature control system fails or not according to the liquid pressure and the temperature of the temperature control target.

In some embodiments, determining whether the temperature control system fails or not according to the liquid pressure and the temperature of the temperature control target includes:
comparing the liquid pressure with a preset pressure range to obtain a first comparison result, and determining whether the cooling assembly fails or not based on the first comparison result; and
if the cooling assembly is operational, comparing the temperature of the temperature control target with a preset temperature to obtain a second comparison result, and determining whether the temperature control assembly fails or not based on the second comparison result.

In some embodiments, comparing the liquid pressure with the preset pressure range to obtain the first comparison result, and determining whether the cooling assembly fails or not based on the first comparison result includes:
if the liquid pressure is within the preset pressure range, determining that the cooling assembly is operational.

In some embodiments, comparing the liquid pressure with the preset pressure range to obtain the first comparison result, and determining whether the cooling assembly fails or not based on the first comparison result includes:
in results for a preset number of consecutive determinations, if the liquid pressure is outside the preset pressure range, determining that the cooling assembly fails.

In some embodiments, comparing the temperature of the temperature control target with the preset temperature to obtain the second comparison result, and determining whether the temperature control assembly fails or not based on the second comparison result includes:
if the temperature of the temperature control target reaches the preset temperature within a preset time, determining that the temperature control assembly is operational; and
if the temperature of the temperature control target does not reach the preset temperature within the preset time, determining that the temperature control assembly fails.

In some embodiments, determining whether the temperature control system fails or not according to the liquid pressure and the temperature of the temperature control target includes:
comparing the liquid pressure with a preset pressure range to obtain a third comparison result, and determining whether the cooling assembly fails or not based on the third comparison result; and
comparing the temperature of the temperature control target with a preset temperature to obtain a fourth comparison result, and determining whether the temperature control assembly fails or not based on the fourth comparison result.

In some embodiments, comparing the liquid pressure with the preset pressure range to obtain the third comparison result, and determining whether the cooling assembly fails or not based on the third comparison result includes:
if the liquid pressure is within the preset pressure range, determining that the cooling assembly is operational.

In some embodiments, the preset pressure range includes a first preset value and a second preset value, the first preset value being a maximum pressure threshold, and the second preset value being a minimum pressure threshold;
comparing the liquid pressure with the preset pressure range to obtain the third comparison result, and determining whether the cooling assembly fails or not based on the third comparison result includes:
if the liquid pressure is greater than the first preset value, determining that a pipeline in the cooling assembly is blocked.

In some embodiments, the preset pressure range includes a first preset value and a second preset value, the first preset value being a maximum pressure threshold, and the second preset value being a minimum pressure threshold;
comparing the liquid pressure with the preset pressure range to obtain the third comparison result, and determining whether the cooling assembly fails or not based on the third comparison result includes:
if the liquid pressure is between a second preset value and a third preset value, determining that a liquid flow rate of the cooling assembly is less than a preset flow rate, where the third preset value is less than the second preset value.

In some embodiments, the preset pressure range includes a first preset value and a second preset value, the first preset value being a maximum pressure threshold, and the second preset value being a minimum pressure threshold;
comparing the liquid pressure with the preset pressure range to obtain the third comparison result, and determining whether the cooling assembly fails or not based on the third comparison result includes:
if the liquid pressure is less than a third preset value, determining that the cooling assembly stops working, and giving an alarm;
where the third preset value is less than the second preset value.

In some embodiments, comparing the temperature of the temperature control target with the preset temperature to obtain the fourth comparison result, and determining whether the temperature control assembly fails or not based on the fourth comparison result includes:
when the pipeline in the cooling assembly is blocked or the liquid flow rate of the cooling assembly is less than the preset flow rate, in results for a preset number of consecutive determinations, if the temperature of the temperature control target does not reach the preset temperature within a preset time, determining that the temperature control assembly fails, and giving an alarm.

In some embodiments, comparing the temperature of the temperature control target with the preset temperature to obtain the fourth comparison result, and determining whether the temperature control assembly fails or not based on the fourth comparison result includes:
when the pipeline in the cooling assembly is blocked or the liquid flow rate of the cooling assembly is less than the preset flow rate, if the temperature of the temperature control target reaches the preset temperature within the preset time, logging liquid pressure data anomaly into an error log.

In some embodiments, the temperature control assembly includes a platform, a thermo electric cooler, and a heat exchanger, where the platform is configured for bearing the temperature control target, the thermo electric cooler is located between the platform and the heat exchanger and configured for heating or refrigerating the temperature control target, and the heat exchanger is configured for exchanging heat with the thermo electric cooler.

In some embodiments, a temperature sensor is arranged in the platform, and the temperature control system acquires the temperature of the temperature control target through the temperature sensor.

In some embodiments, the cooling assembly includes a heat sink and a pump, where the heat sink is configured for dissipating heat from a liquid passing through the heat exchanger, and the pump is configured for enabling the liquid thermally dissipated by the heat sink to enter the heat exchanger again.

In some embodiments, the cooling assembly further includes a liquid reservoir communicating with the pump and the heat sink and configured for storing a liquid.

In some embodiments, the temperature control system further includes a detector located between the pump and the heat exchanger and configured for acquiring the liquid pressure in the cooling assembly.

The temperature control system according to the embodiments of the present application includes the cooling assembly and the temperature control assembly, where the cooling assembly performs liquid-based heat dissipation on the temperature control assembly.

Provided in the embodiments of the present application is a computer device including a memory and a processor, where the processor is configured for executing a computer program stored in the memory to implement the method according to any of the above embodiments.

Provided in the embodiments of the present application is a non-volatile computer-readable storage medium storing a computer program, where the computer program, when executed by one or more processors, causes the processor to implement the method according to any of the above embodiments.

Additional aspects and advantages of the present disclosure will be partially provided in the following description, will partially become apparent from the following description, or will be learned through the practice of the present disclosure.

### BRIEF DESCRIPTION OF THE DRAWINGS

The aforementioned and/or additional aspects and advantages of the present disclosure will become apparent and easily understood from the description of the embodiments with reference to the following drawings, in which:

FIG. 1 is a schematic structural diagram of a temperature control system according to an embodiment of the present disclosure;

FIG. 2 is a schematic flowchart of a detection method according to an embodiment of the present disclosure;

FIG. 3 is a schematic structural diagram of a computer device according to an embodiment of the present disclosure;

FIG. 4 is a schematic flowchart of a detection method according to an embodiment of the present disclosure;

FIG. 5 is a schematic flowchart of a detection method according to an embodiment of the present disclosure;

FIG. 6 is a schematic structural diagram of a temperature control system according to an embodiment of the present disclosure;

FIG. 7 is a schematic structural diagram of a temperature control system according to an embodiment of the present disclosure; and

FIG. 8 is a circuit schematic diagram of a communication module according to an embodiment of the present disclosure.

Description of the reference numerals: 100. temperature control system; 10. temperature control assembly; 11. platform; 12. temperature sensor; 13. thermo electric cooler; 14. heat exchanger; 15. thermally conductive silicone grease; 16. detector; 20. cooling assembly; 21. heat sink; 22. pump; 23. liquid cooling radiator; 24. fan; 25. liquid reservoir; 30. pipeline; 40. main control module; 41. human-machine interface; 50. communication module; 60. adaptation device; 61. pressure control plate; 62. temperature control module; 200. temperature control target; 300. computer device; 310. processor; 320. memory.

### DETAILED DESCRIPTION

The embodiments of the present disclosure are described in detail below, and the examples of the embodiments are shown in the drawings, throughout which identical or similar reference numerals represent identical or similar elements or elements having identical or similar functionality. The embodiments described below with reference to the drawings are exemplary and are merely intended to illustrate the present disclosure, and should not be construed as limiting the present disclosure.

In the description of the present disclosure, it should be understood that orientational or positional relationships indicated by terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, or “counterclockwise”, are those shown on the basis of the drawings, and are merely intended to facilitate and simplify the description rather than indicate or imply that the indicated apparatus or element must have a specific orientation and be configured and operated according to the specific orientation. Such relationships should not be construed as limiting the present disclosure. In addition, the terms “first” and “second” are used herein for descriptive purposes only and should not be construed as indicating or implying relative importance or implicitly indicating the number of technical features described. Therefore, features defined with “first” and “second” may explicitly or implicitly include one or more of the features. In the description of the present disclosure, unless otherwise clearly and specifically defined, the term “plurality” means two or more.

In the description of the present disclosure, it should be noted that unless otherwise clearly specified and defined, the terms “mount”, “link”, and “connect” should be interpreted in their broad sense. For example, the connection may be a fixed connection, detachable connection, or integral connection; a mechanic connection, electric connection, or communicative connection; or a direct connection, indirect connection through an intermediate, internal communication of two elements, or interaction between two elements. For those of ordinary skill in the art, the specific meanings of the aforementioned terms in the present disclosure can be interpreted according to specific conditions.

In the present disclosure, unless otherwise clearly specified and defined, a first feature being “above” or “below” a second feature may include that the first and second features are in direct contact and that the first and second features are not in direct contact but are in contact via an additional feature between them. Moreover, a first feature being “on”, “over”, and “above” a second feature includes that the first feature is right above or obliquely above the second feature, or simply means that the first feature is at a vertically higher position than the second feature. A first feature being “under”, “beneath”, and “below” a second feature includes that the first feature is right below or obliquely below the second feature, or simply means that the first feature is at a vertically lower position than the second feature.

The following disclosure provides many different embodiments or examples for implementing different structures of the present disclosure. To simplify the disclosure of the present application, the components and settings of specific examples are described below. Certainly, the examples are merely exemplary and are not intended to limit the present disclosure. In addition, reference numerals and/or characters may be repeatedly used in different examples in the present disclosure for simplicity and clarity rather than to indicate the relationship between various embodiments and/or settings discussed. In addition, the present disclosure provides examples of various specific processes and materials, but those of ordinary skill in the art will recognize the application of other processes and/or the use of other materials.

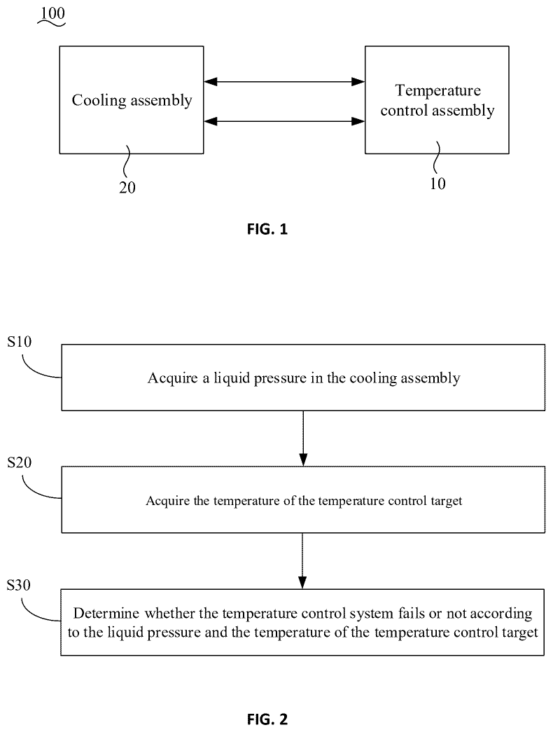

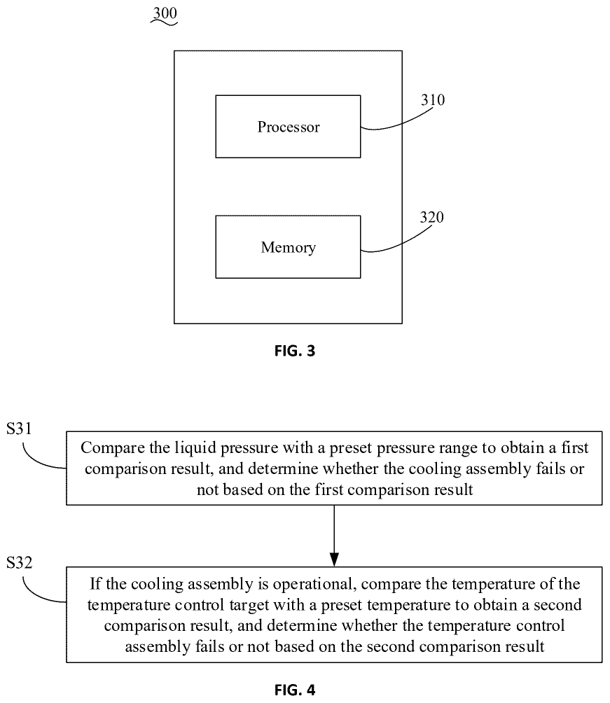

Referring to FIGS. 1 and 2, provided in the embodiments of the present application is a method for detecting a temperature control system 100, where the temperature control system 100 includes a temperature control assembly 10 and a cooling assembly 20, the temperature control assembly 10 being configured for controlling a temperature of a temperature control target 200, and the cooling assembly 20 being configured for performing liquid-based heat dissipation on heat generated by the temperature control assembly 10, and the method includes:

S10, acquiring a liquid pressure in the cooling assembly 20;

S20, acquiring the temperature of the temperature control target 200; and

S30, determining whether the temperature control system 100 fails or not according to the liquid pressure and the temperature of the temperature control target 200.

Referring to FIG. 3, provided in the embodiments of the present application is a computer device 300 including a memory 320 and a processor 310, where the processor 310 is configured for executing a computer program stored in the memory 320 to implement the method according to any of the above embodiments. For example, the processor 310 is configured for acquiring the liquid pressure in the cooling assembly 20; and for acquiring the temperature of the temperature control target 200; and for determining whether the temperature control system 100 fails or not according to the liquid pressure and the temperature of the temperature control target 200.

Therefore, whether the temperature control system 100 fails or not is determined based on the liquid pressure of the cooling assembly 20 and the temperature of the temperature control target 200, and the temperature control system 100 can be monitored to meet the requirement of the temperature control target 200 on the required temperature; meanwhile, the temperature anomaly of the temperature control target 200 caused by the reduction of the temperature control efficiency due to the failure of the temperature control system 100 can be prevented.

Specifically, the temperature control target 200 may be a flow cell, which may also be referred to as a chip, configured for providing a site for sequencing to perform a biochemical reaction, and capable of accommodating reagents and samples for the reaction. The flow cell includes a solid substrate, which is provided with a surface capable of connecting or fixing target biomolecules, where the surface may be a curved surface or a plane.

The temperature control assembly 10 and the cooling assembly 20 may be connected by a pipeline 30. The liquid in the cooling assembly 20 may be a cooling liquid, the liquid pressure may be acquired by reading the value from the detector 16, and the temperature of the temperature control target 200 may be acquired by reading the value from the temperature sensor 12. The failure of the temperature control system 100 may be a failure of the cooling assembly 20, a failure of the temperature control assembly 10, or a failure of both the temperature control assembly 10 and the cooling assembly 20.

When the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also changes. For example, when a pipeline 30 for a liquid to flow of the cooling assembly 20 is blocked, the liquid pressure in the pipeline 30 may increase; when the liquid flow rate of the cooling assembly 20 becomes smaller, the liquid pressure decreases; when the cooling assembly 20 stops working, the liquid pressure greatly decreases.

When the temperature control assembly 10 is in normal operation, the temperature of the temperature control target 200 gradually approaches the preset temperature with the passage of time, and if the temperature control assembly 10 fails, the temperature anomaly of the temperature control target 200 occurs within the preset time. For example, when the contact of the thermo electric cooler 13 with the heat exchanger 14 or the platform 11 is insufficient, the temperature of the temperature control target 200 deviates from the preset temperature within the preset time.

The failure of the temperature control system 100 may be detected when the computer device 300 is turned on, so as to meet the normal use requirement of users; or the detection may be performed during the biochemical reaction using the temperature control target 200 to ensure the normal performance of the biochemical reaction.

Referring to FIG. 4, in some embodiments, determining whether the temperature control system 100 fails or not according to the liquid pressure and the temperature of the temperature control target 200 (S30) includes:

S31, comparing the liquid pressure with a preset pressure range to obtain a first comparison result, and determining whether the cooling assembly 20 fails or not based on the first comparison result; and

S32, if the cooling assembly 20 is operational, comparing the temperature of the temperature control target 200 with a preset temperature to obtain a second comparison result, and determining whether the temperature control assembly 10 fails or not based on the second comparison result.

In some embodiments, the processor 310 is configured for comparing the liquid pressure with the preset pressure range to obtain the first comparison result, and determining whether the cooling assembly 20 fails or not based on the first comparison result; and for, when the cooling assembly 20 is operational, comparing the temperature of the temperature control target 200 with a preset temperature to obtain the second comparison result, and determining whether the temperature control assembly 10 fails or not based on the second comparison result.

Specifically, when the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also changes. Therefore, it is possible to determine whether the cooling assembly 20 fails or not based on the comparison result between the liquid pressure and the preset pressure range, which makes the failure determination of the cooling assembly 20 easier and more convenient.

Similarly, when the temperature control assembly 10 is in normal operation, the temperature of the temperature control target 200 gradually approaches the preset temperature with the passage of time, and if the temperature control assembly 10 fails, the temperature of the temperature control target 200 deviates from the preset temperature. Therefore, it is possible to determine whether the temperature control assembly 10 fails or not based on the comparison result between the temperature of the temperature control target 200 and the preset temperature, which makes the failure determination of the temperature control assembly 10 easier and more convenient.

It can be understood that the liquid pressure may vary depending on the volume of the liquid, the type of the liquid, etc. when the liquid flows normally in the cooling assembly 20, and thus, the preset pressure range may be determined based on the volume of the liquid and the type of the liquid. The preset pressure range may be determined in advance by means of experiments, calculations, etc.

The preset temperature may be determined according to a temperature required for a biochemical reaction performed in the temperature control target 200, and the biochemical reaction may be affected by an excessively high or excessively low temperature of the temperature control target 200, thereby affecting the reaction efficiency. The preset temperature may be determined in advance by means of experiments, calculations, etc.

In some embodiments, comparing the liquid pressure with the preset pressure range to obtain the first comparison result, and determining whether the cooling assembly 20 fails or not based on the first comparison result includes:
if the liquid pressure is within the preset pressure range, determining that the cooling assembly 20 is operational.

In some embodiments, the processor 310 is configured for determining that the cooling assembly 20 is operational when the liquid pressure is within the preset pressure range.

Specifically, when the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also increases or decreases. Therefore, when the liquid pressure is within the preset pressure range, it is determined that the cooling assembly 20 is operational, such that the failure determination of the cooling assembly 20 is more accurate and effective.

In some embodiments, comparing the liquid pressure with the preset pressure range to obtain the first comparison result, and determining whether the cooling assembly 20 fails or not based on the first comparison result includes:

in results for a preset number of consecutive determinations, if the liquid pressure is outside the preset pressure range, determining that the cooling assembly 20 fails.

In some embodiments, the processor 310 is configured for determining that the cooling assembly 20 fails when the liquid pressure is outside the preset pressure range in results for a preset number of consecutive determinations.

Specifically, when the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also increases or decreases. Therefore, in the results for a preset number of consecutive determinations, if the liquid pressure is outside the preset pressure range, it is determined that the cooling assembly 20 fails, such that the failure determination of the cooling assembly 20 is more accurate and effective.

In one embodiment, a preset number of consecutive determinations refer to that the frequency of reading the liquid pressure is 1 s/time, if the liquid pressure is outside the preset pressure range for 20 consecutive determinations, it is recorded that the liquid pressure does not reach the standard once, and the liquid pressure is read again, and if the liquid pressure does not reach the standard for three consecutive determinations, it is determined that the cooling assembly 20 fails.

In some embodiments, comparing the temperature of the temperature control target 200 with the preset temperature to obtain the second comparison result, and determining whether the temperature control assembly 10 fails or not based on the second comparison result includes:
if the temperature of the temperature control target 200 reaches the preset temperature within a preset time, determining that the temperature control assembly 10 is operational; and if the temperature of the temperature control target 200 does not reach the preset temperature within the preset time, determining that the temperature control assembly 10 fails.

In some embodiments, the processor 310 is configured for determining that the temperature control assembly 10 is operational when the temperature of the temperature control target 200 reaches the preset temperature within a preset time; and for determining that the temperature control assembly 10 fails when the temperature of the temperature control target 200 does not reach the preset temperature within the preset time.

Specifically, when the temperature control assembly 10 is in normal operation, the temperature of the temperature control target 200 reaches the preset temperature within the preset time with the passage of time, and if the temperature control assembly 10 fails, the temperature of the temperature control target 200 deviates from the preset temperature within the preset time. Therefore, whether the temperature control assembly 10 fails or not is determined based on the comparison result between the temperature of the temperature control target 200 within the preset time and the preset temperature, such that the failure determination of the temperature control assembly 10 is more accurate and effective.

In one embodiment, the preset time is 60 s, the preset temperature is 25° C., and if the temperature of the temperature control target 200 stabilizes at 25° C. within 60 s, it is determined that the temperature control assembly 10 is operational; if the temperature of the temperature control target 200 cannot stabilize at 25° C. within 60 s, it is determined that the temperature control assembly 10 fails.

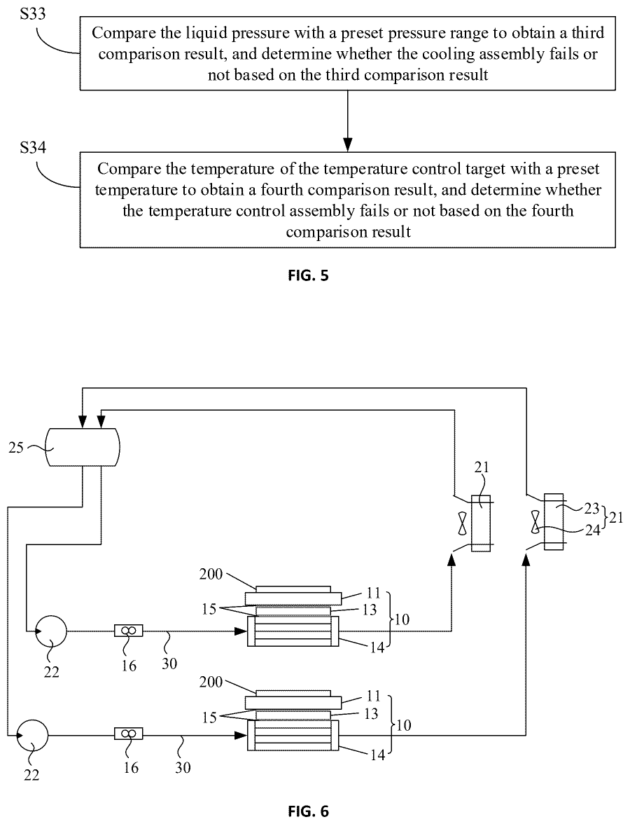

Referring to FIG. 5, in some embodiments, determining whether the temperature control system 100 fails or not according to the liquid pressure and the temperature of the temperature control target 200 (S30) includes:

S33, comparing the liquid pressure with a preset pressure range to obtain a third comparison result, and determining whether the cooling assembly 20 fails or not based on the third comparison result; and

S34, comparing the temperature of the temperature control target 200 with a preset temperature to obtain a fourth comparison result, and determining whether the temperature control assembly 10 fails or not based on the fourth comparison result.

In some embodiments, the processor 310 is configured for comparing the liquid pressure with the preset pressure range to obtain the third comparison result, and determining whether the cooling assembly 20 fails or not based on the third comparison result; and for comparing the temperature of the temperature control target 200 with the preset temperature to obtain the fourth comparison result, and determining whether the temperature control assembly 10 fails or not based on the fourth comparison result.

Specifically, when the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also changes. Therefore, it is possible to determine whether the cooling assembly 20 fails or not based on the comparison result between the liquid pressure and the preset pressure range, which makes the failure determination of the cooling assembly 20 easier and more convenient.

Similarly, when the temperature control assembly 10 is in normal operation, the temperature of the temperature control target 200 gradually approaches the preset temperature with the passage of time, and if the temperature control assembly 10 fails, the temperature of the temperature control target 200 deviates from the preset temperature. Therefore, it is possible to determine whether the temperature control assembly 10 fails or not based on the comparison result between the temperature of the temperature control target 200 and the preset temperature, which makes the failure determination of the temperature control assembly 10 easier and more convenient.

In some embodiments, comparing the liquid pressure with the preset pressure range to obtain the third comparison result, and determining whether the cooling assembly 20 fails or not based on the third comparison result includes:
if the liquid pressure is within the preset pressure range, determining that the cooling assembly 20 is operational.

In some embodiments, the processor 310 is configured for determining that the cooling assembly 20 is operational when the liquid pressure is within the preset pressure range.

Specifically, when the liquid flows normally in the cooling assembly 20, the liquid pressure of the cooling assembly 20 is kept within a preset pressure range, and if the cooling assembly 20 fails, the flow state of the liquid in the cooling assembly 20 changes, and the liquid pressure also increases or decreases. Therefore, when the liquid pressure is within the preset pressure range, it is determined that the cooling assembly 20 is operational, such that the failure determination of the cooling assembly 20 is more accurate and effective.

In some embodiments, the preset pressure range includes a first preset value and a second preset value, the first preset value being a maximum pressure threshold, and the second preset value being a minimum pressure threshold;
comparing the liquid pressure with the preset pressure range to obtain the third comparison result, and determining whether the cooling assembly 20 fails or not based on the third comparison result includes:
if the liquid pressure is greater than the first preset value, determining that a pipeline 30 in the cooling assembly 20 is blocked.

In some embodiments, the processor 310 is configured for determining that the pipeline 30 in the cooling assembly 20 is blocked when the liquid pressure is greater than a first preset value.

Specifically, when the liquid flows normally in the cooling assembly 20, the liquid pressure of the cooling assembly 20 is kept within a preset pressure range, and if the pipeline 30 in the cooling assembly 20 is blocked, the liquid pressure in the pipeline 30 increases. Therefore, when the liquid pressure is greater than the first preset value, it is determined that the pipeline 30 in the cooling assembly 20 is blocked, such that the failure determination of the cooling assembly 20 is more accurate and effective.

In some embodiments, comparing the liquid pressure with the preset pressure range to obtain the third comparison result, and determining whether the cooling assembly 20 fails or not based on the third comparison result includes:
if the liquid pressure is between a second preset value and a third preset value, determining that a liquid flow rate of the cooling assembly 20 is less than a preset flow rate, where the third preset value is less than the second preset value.

In some embodiments, the processor 310 is configured for determining that the liquid flow rate of the cooling assembly 20 is less than the preset flow rate when the liquid pressure is between a second preset value and a third preset value.

Specifically, the third preset value is a threshold at which the liquid pressure is at an absolutely low value when the cooling assembly 20 stops working. When the liquid flows normally in the cooling assembly 20, the liquid pressure of the cooling assembly 20 is kept within a preset pressure range, and if the liquid flow rate of the cooling assembly 20 becomes smaller, the liquid pressure decreases. Therefore, when the liquid pressure is between the second preset value and the third preset value, it is determined that the liquid flow rate of the cooling assembly 20 is less than the preset flow rate, such that the failure determination of the cooling assembly 20 is more accurate and effective. The preset flow rate may be a liquid flow rate when the cooling assembly 20 is operational, and the preset flow rate may be determined in advance by means of experiments, calculations, etc.

In some embodiments, comparing the liquid pressure with the preset pressure range to obtain the third comparison result, and determining whether the cooling assembly 20 fails or not based on the third comparison result includes:
if the liquid pressure is less than a third preset value, determining that the cooling assembly 20 stops working, and giving an alarm.

In some embodiments, the processor 310 is configured for, when the liquid pressure is less than a third preset value, determining that the cooling assembly 20 stops working, and giving an alarm.

Specifically, when the liquid flows normally in the cooling assembly 20, the liquid pressure of the cooling assembly 20 is kept within a preset pressure range, and if the cooling assembly 20 stops working, the liquid pressure also greatly decreases. Therefore, when the liquid pressure is less than the third preset value, it is determined that the cooling assembly 20 stops working, such that the failure determination of the cooling assembly 20 is more accurate and effective. The manner of giving an alarm may be to sound a buzzer, turn on an alarm lamp, present an alarm prompt pop-up window on a display screen of a display, or the like.

In some embodiments, comparing the temperature of the temperature control target 200 with the preset temperature to obtain the fourth comparison result, and determining whether the temperature control assembly 10 fails or not based on the fourth comparison result includes:
when the pipeline 30 in the cooling assembly 20 is blocked or the liquid flow rate of the cooling assembly 20 is less than the preset flow rate, in results for a preset number of consecutive determinations, if the temperature of the temperature control target 200 does not reach the preset temperature within a preset time, determining that the temperature control assembly 10 fails, and giving an alarm.

In some embodiments, the processor 310 is configured for, when the pipeline 30 in the cooling assembly 20 is blocked or the liquid flow rate of the cooling assembly 20 is less than the preset flow rate, in results for a preset number of consecutive determinations, if the temperature of the temperature control target 200 does not reach the preset temperature within a preset time, determining that the temperature control assembly 10 fails, and giving an alarm.

Specifically, when the liquid pressure of the cooling assembly 20 is greater than a first preset value or is between a second preset value and a third preset value, if the temperature control assembly 10 works normally, the temperature of the temperature control target 200 reaches the preset temperature within the preset time with the passage of time, and if the temperature control assembly 10 fails, the temperature of the temperature control target 200 deviates from the preset temperature within the preset time. Therefore, whether the temperature control assembly 10 fails or not is determined based on the comparison result between the temperature of the temperature control target 200 within the preset time and the preset temperature for a preset number of consecutive comparisons, such that the failure determination of the temperature control assembly 10 is more accurate and effective.

In one embodiment, a preset number of consecutive determinations refer to that the temperature of the temperature control target 200 does not reach 25° C. within 60 s for three consecutive times, and it is determined that the temperature control assembly 10 fails.

In some embodiments, comparing the temperature of the temperature control target 200 with the preset temperature to obtain the fourth comparison result, and determining whether the temperature control assembly 10 fails or not based on the fourth comparison result includes:
when the pipeline 30 in the cooling assembly 20 is blocked or the liquid flow rate of the cooling assembly 20 is less than the preset flow rate, if the temperature of the temperature control target 200 reaches the preset temperature within the preset time, logging liquid pressure data anomaly into an error log.

In some embodiments, the processor 310 is configured for, when the pipeline 30 in the cooling assembly 20 is blocked or the liquid flow rate of the cooling assembly 20 is less than the preset flow rate, if the temperature of the temperature control target 200 reaches the preset temperature within the preset time, logging liquid pressure data anomaly into an error log.

Specifically, when the liquid pressure of the cooling assembly 20 is greater than a first preset value or is between a second preset value and a third preset value, if the temperature control assembly 10 works normally, the temperature of the temperature control target 200 reaches the preset temperature within the preset time with the passage of time. Therefore, whether the temperature control assembly 10 fails or not is determined based on the comparison result between the temperature of the temperature control target 200 within the preset time and the preset temperature, such that the failure determination of the temperature control assembly 10 is more accurate and effective.

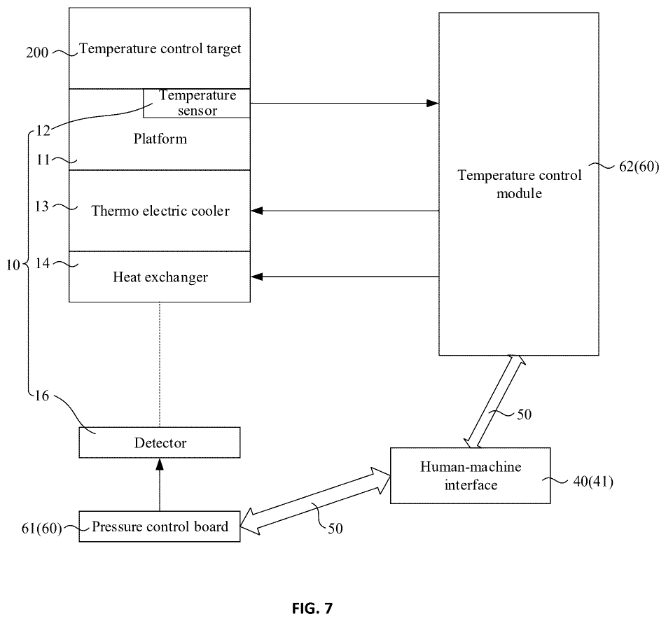

Referring to FIG. 6, in some embodiments, the temperature control assembly 10 includes a platform 11, a thermo electric cooler 13, and a heat exchanger 14, where the platform 11 is configured for bearing the temperature control target 200, the thermo electric cooler 13 is located between the platform 11 and the heat exchanger 14 and configured for heating or refrigerating the temperature control target 200, and the heat exchanger 14 is configured for exchanging heat with the thermo electric cooler 13.

In this way, the thermo electric cooler 13 can control the temperature of the temperature control target 200, thereby controlling the reaction temperature of the temperature control target 200 and preventing the reaction efficiency from being affected by an excessively high temperature. Specifically, the shape of the platform 11 may be a rectangular parallelepiped, and the dimension of the platform 11 may be larger than that of the temperature control target 200. The temperature control target 200 may be fixed on the platform 11 by detachable connections such as vacuum adsorption, magnetic attraction, adhesion, and snap-fitting.

The thermo electric cooler 13 may also be called a Peltier, and the thermo electric cooler 13 achieves a refrigerating or heating effect based on the Peltier effect, and the refrigerating or heating principle is that: when the current passes through two types of connected conductors, the temperature difference occurs at the joint, that is, the phenomena of heat absorption and heat release occur at the joint. The amount of heat absorption and heat release in the Peltier effect is determined based on the magnitude of the current. The upper and lower surfaces of the thermo electric cooler 13 can be coated with thermally conductive silicone grease 15 and are respectively connected to the platform 11 and the heat exchanger 14, thereby uniformly transferring the heat on the upper and lower surfaces of the thermo electric cooler 13. The thermo electric cooler 13 includes a first surface and a second surface which are opposite to each other, the thermo electric cooler 13 starts to work after being electrified, and at the moment, one of the first surface and the second surface starts to initiate cooling, and the other surface starts to generate heat. For example, when the thermo electric cooler 13 starts to work, the first surface starts to initiate cooling and the second surface starts to generate heat. It can be understood that the type of cooling of the first surface is different when the operating current of the thermo electric cooler 13 is different. For example, when the operating current of the thermo electric cooler 13 is forward, the first surface initiates cooling; when the operating current of the thermo electric cooler 13 is reverse, the first surface generates heat. Compared with other refrigerating elements, the thermo electric cooler 13 has the advantages of being more environment-friendly and not generating noise.

The heat exchanger 14 may be a water-cooling heat exchanger or a water-cooling tank, and the heat or cold of the contact surface with the thermo electric cooler 13 can be taken away by the liquid flowing into the heat exchanger 14, such that the working efficiency of the thermo electric cooler 13 can be optimal.

Referring to FIG. 7, in some embodiments, a temperature sensor 12 is arranged in the platform 11, and the temperature control system 100 acquires the temperature of the temperature control target 200 through the temperature sensor 12.

In this way, the temperature sensor 12 acquires the temperature of the temperature control target 200 in real time, so as to determine whether the temperature control assembly 10 fails or not, thereby further improving the reliability of the temperature control system 100.

Specifically, the temperature sensor 12 may be arranged between the platform 11 and the temperature control target 200, and the temperature sensor 12 may be in contact with the temperature control target 200 to detect the temperature of the temperature control target 200. The temperature sensor 12 may be one, two or more of any combination of a PTC thermistor, an NTC thermistor, a bimetallic strip, a thermocouple, a quartz crystal temperature sensor, an optical fiber temperature sensor, an infrared temperature sensor, and a P-N junction temperature sensor.

Referring to FIG. 6, in some embodiments, the cooling assembly 20 includes a heat sink 21 and a pump 22, where the heat sink 21 is configured for dissipating heat from a liquid passing through the heat exchanger 14, and the pump 22 is configured for enabling the liquid thermally dissipated by the heat sink 21 to enter the heat exchanger 14 again.

In this way, the heat sink 21 dissipates heat from the liquid passing through the heat exchanger 14, such that the liquid can be recycled. The pump 22 drives the liquid to flow between the heat exchanger 14 and the heat sink 21, such that the heat exchange with the thermo electric cooler 13 is achieved.

Specifically, the heat sink 21 may be made of a metal material including, but not limited to, aluminum, copper, and the like. The heat sink 21 may be arranged downstream of the heat exchanger 14 to dissipate heat from the liquid flowing through the heat exchanger 14. The heat sink 21 includes a liquid cooling radiator 23 and a fan 24, where the fan 24 accelerates the cooling of the liquid as the liquid flows through the liquid cooling radiator 23.

The pump 22 is a mechanism for delivering or pressurizing a liquid, the pump 22 may be arranged upstream of the heat exchanger 14, the pump 22 may be a peristaltic pump, a plunger pump, a syringe pump, a gear pump, a diaphragm pump, or the like, and the pump 22 may provide both a negative pressure or a positive pressure. The heat exchanger 14 communicates with the pump 22 and the heat sink 21 via the pipeline 30.

Referring to FIG. 6, in some embodiments, the cooling assembly 20 further includes a liquid reservoir 25 communicating with the pump 22 and the heat sink 21 and configured for storing a liquid.

Therefore, the liquid reservoir 25 is capable of recovering a liquid, the liquid can be conveniently recycled, thus improving the utilization rate of the liquid, and saving the cost.

Specifically, the liquid reservoir 25 may be a box structure, and the liquid reservoir 25 may include a liquid inlet and a liquid outlet, where the liquid inlet is connected to the heat sink 21 to recover the liquid thermally dissipated by the heat sink 21, and the liquid outlet is connected to the pump 22 to allow the stored liquid to flow to the heat exchanger 14 through the pump 22. The liquid reservoir 25 communicates with the pump 22 and the heat sink 21 via the pipeline 30.

Referring to FIG. 6, in some embodiments, the temperature control system 100 further includes a detector 16 located between the pump 22 and the heat exchanger 14 and configured for acquiring the liquid pressure in the cooling assembly 20.

In this way, the detector 16 monitors the liquid pressure in the cooling assembly 20 in real time, so as to determine whether the cooling assembly 20 is working normally, and give an alarm in advance, thereby further improving the reliability of the temperature control system 100.

Specifically, the detector 16 is installed at the head end of the cooling assembly 20, namely, at the pump liquid outlet of the pump 22, the liquid pressure at the pump liquid outlet is at a high value, and the pressure fluctuation and anomaly sensitivity are higher, so the detection sensitivity can be improved, such that the liquid pressure fluctuation or anomaly can be found at the first time, and the operation safety of the temperature control system 100 is ensured. The detector 16 may be a liquid pressure sensor, and further, the detector 16 is a micro-piezoresistive pressure sensor, with the pressure type as gauge pressure. The piezoresistive pressure sensor adopts an integrated circuit process technology; four equivalent thin film resistors are manufactured on a silicon chip to form a Wheatstone bridge circuit, the piezoresistive pressure sensor is connected to the Wheatstone bridge circuit via a lead, and according to the piezoelectric effect of surface resistors, the Wheatstone bridge circuit is in a balanced state with no voltage output when the four resistors are free from pressure; the Wheatstone bridge circuit is out of balance and outputs a voltage signal corresponding to the pressure when the resistors are subjected to pressure. Due to temperature-dependent variations in diffusion resistance and piezoresistive coefficient, both zero-point drift and sensitivity drift occur, and therefore, series and parallel resistors are required to be employed for zero calibration and temperature compensation. In this way, the resistance variation of the sensor is converted into a pressure signal output through the Wheatstone bridge circuit. The bridge detects the variation in resistance, followed by curve fitting, linearity compensation, amplification by an amplifier circuit, and then voltage-to-current conversion, and an output voltage signal of a millivolt-level that linearly corresponds to the input voltage is generated.

Referring to FIG. 7, in one embodiment, the temperature control system 100 includes a main control module 40, a communication module 50, and an adaptation device 60, and the pressure sensor employs a 4-wire system with a 5V DC output; when the liquid pressure increases or decreases, the pressure sensor converts the measured pressure into an output voltage signal, sends the output voltage signal to the main control module 40, and sends the output voltage signal to the adaptation device 60 through the communication module 50, and the requirements of transmission, processing, storage, display, recording, control and the like of the liquid pressure of the pump 22 are met according to a fitted linear curve between the pressure and the output voltage.

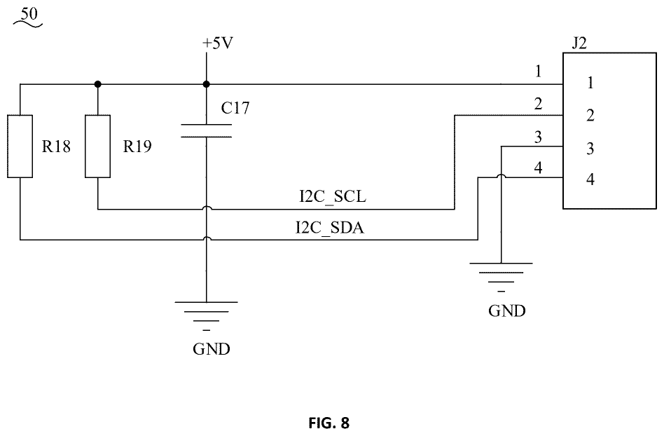

The communication module 50 is capable of connecting and communicating with the adaptation device 60 of the same communication method corresponding to/matching/adapting to the communication method thereof, and in conjunction with FIG. 8, the communication module 50 is an I2C communication interface module. The connector J2 may be an I2C interface, and the communication with other external adaptation devices 60 having I2C communication function can be achieved through the connector J2. The connector J2 includes four ports, where the No. 1 port is connected to a power supply; the No. 2 port and the No. 4 port are communication ports, which are connected to the main control module 40 and are configured for transmitting a signal from the main control module 40 to the adaptation device 60 in an I2C manner; the No. 3 port is grounded. In the embodiments of the present disclosure, unless otherwise specified, “being grounded” refers to connection to digital ground. The communication module 50 further includes a resistor R18, a resistor R19, and a capacitor C17. One terminal of the resistor R19 is connected to a 5V power supply, and the other terminal is connected to the No. 2 port of the connector J2. One terminal of the resistor R18 is connected to the 5V power supply, and the other terminal is connected to the No. 4 port of the connector J2. One terminal of the capacitor C17 is connected to the 5V power supply, and the other terminal is grounded. The capacitor C17 is a filter capacitor, which can play a role in reducing interference. The resistor R18 and the resistor R19 are pull-up resistors, which provide a pull-up level for the main control module 40.

Referring to FIG. 7, the main control module 40 may be a human-machine interface 41, and the adaptation device 60 may be a pressure control board 61 and a temperature control module 62, where the temperature control module 62 is powered by a DC power supply, the human-machine interface 41 transmits an output voltage signal to the pressure control board 61 and the temperature control module 62 through the communication module 50, the pressure control board 61 supplies power to the detector 16 and outputs voltage; a preset temperature is transmitted to the temperature control module 62 through the human-machine interface 41, and the temperature control module 62 acquires a detection temperature of the temperature sensor 12, controls the heating/cooling rate and the temperature accuracy of the temperature control target 200 by means of a PID control algorithm, adjusts the power of the thermo electric cooler 13, and adjusts the power of the heat exchanger 14.

Referring to FIG. 1, the temperature control system 100 according to the embodiments of the present application includes the cooling assembly 20 and the temperature control assembly 10, where the cooling assembly 20 performs liquid-based heat dissipation on the temperature control assembly 10.

In this way, whether the temperature control system 100 fails or not is determined by the cooling assembly 20 and the temperature control assembly 10, and the temperature control system 100 is monitored to meet the requirement of the temperature control target 200 for the required temperature. Meanwhile, the failure of the temperature control system 100 and the temperature anomaly of the temperature control target 200 caused by the reduction of the temperature control efficiency are prevented.

Specifically, the number of the cooling assemblies 20 and the temperature control assemblies 10 may be one or more, for example, one, two, three, etc., and the plurality of cooling assemblies 20 and the plurality of temperature control assemblies 10 are connected in a one-to-one correspondence manner. The number of the liquid reservoir 25 may be one, and for example, one liquid reservoir 25 is connected to two pumps 22 and two heat sinks 21.

Provided in the embodiments of the present application is a non-volatile computer-readable storage medium storing a computer program, where the computer program, when executed by one or more processors 310, causes the processor to implement the method according to any of the above embodiments. Specifically, the processor 310 performs any of the steps of the detection method.

Any process or method in the flowchart or otherwise described herein should be understood as representing a module, segment or portion of code including one or more executable instructions for implementing steps of specific logical functions or processes, and the scope of preferred embodiments of the present application includes additional implementations, in which functions can be performed not in the order shown or discussed, including in a substantially simultaneous manner or in the reverse order, depending on the function involved, as should be understood by those skilled in the art to which embodiments of the present application belong.

Logic and/or steps shown in the flowcharts or otherwise described herein, for example, may be considered as a program list of executable instructions that are configured to implement logical functions, and may be specifically implemented on any computer-readable medium, for use by an instruction execution system, apparatus, or device (for example, a computer-based system, a system including a processing module, or another system that can fetch instructions from the instruction execution system, apparatus, or device and execute the instructions), or for use in combination with the instruction execution system, apparatus, or device. As used herein, the “computer-readable medium” may be any apparatus that may include, store, communicate, propagate, or transmit a program for use by an instruction execution system, apparatus, or device, or for use in combination with the instruction execution system, apparatus, or device. More specific examples (this list is not exhaustive) of the computer-readable medium include the following: an electrical connection portion (an electrical device) with one or more buses, a portable computer cartridge (a magnetic device), a random-access memory (RAM), a read-only memory (ROM), an erasable programmable read-only memory (EPROM or flash memory), an optical fiber device, and a portable compact disc read-only memory (CDROM). In addition, the computer-readable medium may even be a piece of paper on which the programs can be printed or any other appropriate media, because, for example, the paper or the media may be optically scanned, and the program may be electrically acquired by processing such as edition, decoding, or any other appropriate means when necessary and then stored in a computer memory 320.

The processor 310 may be a central processing unit (CPU), or some other general-purpose processor, a digital signal processor (DSP), an application specific integrated circuit (ASIC), a field-programmable gate array (FPGA) or some other programmable logic device, a discrete gate or transistor logic device, a discrete hardware component, etc. The general-purpose processor may be a microprocessor or the processor may be any conventional processor.

It should be understood that each of the portions of the embodiments of the present application can be implemented in hardware, software, firmware, or a combination thereof. In the above embodiments, a plurality of steps or methods can be implemented in software or firmware stored in a memory 320 and executed by an appropriate instruction execution system. For example, the steps or methods, if implemented in hardware, as in another embodiment, can be implemented through any one or a combination of the following technologies, which are well known in the art: a discrete logic circuit having a logic gate circuit for implementing a logic function on a data signal, a specific integrated circuit having an appropriate combinational logic gate circuit, a programmable gate array (PGA), a field programmable gate array (FPGA), and the like.

It can be understood by those skilled in the art that all or part of the steps implementing the method of the above embodiments can be implemented by instructing relevant hardware by means of a program. The program can be stored in a computer-readable storage medium, and the program, when executed, can implement one or a combination of the steps of the method embodiments.

In addition, each of the functional units in each of the embodiments of the present application may be integrated in one processing module, or each of the units may physically exist alone, or two or more than two units may be integrated in one module. The integrated module described above may be implemented in the form of hardware or in the form of a software functional module. The integrated module may also be stored in a computer-readable storage medium if it is implemented in the form of a software functional module and is sold or used as standalone products.

The storage medium described above may be a read-only memory, a magnetic disk or an optical disk, etc.

In the description of the specification, references to the terms such as “an embodiment”, “some embodiments”, “schematic embodiments”, “examples”, “specific examples”, or “some examples” mean that the specific feature, structure, material, or characteristic described in connection with the embodiment or example is included in at least one embodiment or example of the present disclosure. In the specification, the schematic description of the aforementioned terms does not necessarily refer to the same embodiment or example. Moreover, the specific feature, structure, material, or characteristic described may be combined in any one or more embodiments or examples in an appropriate manner.

Although the embodiments of the present disclosure have been illustrated and described, it can be understood by those of ordinary skill in the art that various changes, modifications, replacements, and variations can be made to these embodiments without departing from the principle and purpose of the present disclosure, and the scope of the present disclosure is defined by the claims and equivalents therefore.

1-20. (canceled)

21. A method for detecting a temperature control system, wherein the temperature control system comprises a temperature control assembly and a cooling assembly, the temperature control assembly being configured for controlling a temperature of a temperature control target, and the cooling assembly being configured for performing liquid-based heat dissipation on heat generated by the temperature control assembly, and the method comprises:
acquiring a liquid pressure in the cooling assembly;
acquiring the temperature of the temperature control target; and
determining whether the temperature control system fails or not according to the liquid pressure and the temperature of the temperature control target.

22. The method according to claim 21, wherein determining whether the temperature control system fails or not according to the liquid pressure and the temperature of the temperature control target comprises:
comparing the liquid pressure with a preset pressure range to obtain a first comparison result, and determining whether the cooling assembly fails or not based on the first comparison result; and
if the cooling assembly is operational, comparing the temperature of the temperature control target with a preset temperature to obtain a second comparison result, and determining whether the temperature control assembly fails or not based on the second comparison result.

23. The method according to claim 22, wherein comparing the liquid pressure with the preset pressure range to obtain the first comparison result, and determining whether the cooling assembly fails or not based on the first comparison result comprises:
if the liquid pressure is within the preset pressure range, determining that the cooling assembly is operational.

24. The method according to claim 22, wherein comparing the liquid pressure with the preset pressure range to obtain the first comparison result, and determining whether the cooling assembly fails or not based on the first comparison result comprises:
in results for a preset number of consecutive determinations, if the liquid pressure is outside the preset pressure range, determining that the cooling assembly fails.

25. The method according to claim 22, wherein comparing the temperature of the temperature control target with the preset temperature to obtain the second comparison result, and determining whether the temperature control assembly fails or not based on the second comparison result comprises:
if the temperature of the temperature control target reaches the preset temperature within a preset time, determining that the temperature control assembly is operational;
otherwise, determining that the temperature control assembly fails.

26. The method according to claim 21, wherein determining whether the temperature control system fails or not according to the liquid pressure and the temperature of the temperature control target comprises:
comparing the liquid pressure with a preset pressure range to obtain a third comparison result, and determining whether the cooling assembly fails or not based on the third comparison result; and
comparing the temperature of the temperature control target with a preset temperature to obtain a fourth comparison result, and determining whether the temperature control assembly fails or not based on the fourth comparison result.

27. The method according to claim 26, wherein comparing the liquid pressure with the preset pressure range to obtain the third comparison result, and determining whether the cooling assembly fails or not based on the third comparison result comprises:
if the liquid pressure is within the preset pressure range, determining that the cooling assembly is operational.

28. The method according to claim 26, wherein the preset pressure range comprises a first preset value and a second preset value, the first preset value being a maximum pressure threshold, and the second preset value being a minimum pressure threshold;
comparing the liquid pressure with the preset pressure range to obtain the third comparison result, and determining whether the cooling assembly fails or not based on the third comparison result comprises:
if the liquid pressure is greater than the first preset value, determining that a pipeline in the cooling assembly is blocked.

29. The method according to claim 26, wherein comparing the liquid pressure with the preset pressure range to obtain the third comparison result, and determining whether the cooling assembly fails or not based on the third comparison result comprises:
if the liquid pressure is between a second preset value and a third preset value, determining that a liquid flow rate of the cooling assembly is less than a preset flow rate, wherein the third preset value is less than the second preset value.

30. The method according to claim 26, wherein comparing the liquid pressure with the preset pressure range to obtain the third comparison result, and determining whether the cooling assembly fails or not based on the third comparison result comprises:
if the liquid pressure is less than a third preset value, determining that the cooling assembly stops working, and giving an alarm.

31. The method according to claim 28, wherein comparing the temperature of the temperature control target with the preset temperature to obtain the fourth comparison result, and determining whether the temperature control assembly fails or not based on the fourth comparison result comprises:
when the pipeline in the cooling assembly is blocked or the liquid flow rate of the cooling assembly is less than the preset flow rate, in results for a preset number of consecutive determinations, if the temperature of the temperature control target does not reach the preset temperature within a preset time, determining that the temperature control assembly fails, and giving an alarm.

32. The method according to claim 31, wherein comparing the temperature of the temperature control target with the preset temperature to obtain the fourth comparison result, and determining whether the temperature control assembly fails or not based on the fourth comparison result comprises:
when the pipeline in the cooling assembly is blocked or the liquid flow rate of the cooling assembly is less than the preset flow rate, if the temperature of the temperature control target reaches the preset temperature within the preset time, logging liquid pressure data anomaly into an error log.

33. The method according to claim 21, wherein the temperature control assembly comprises a platform, a thermo electric cooler, and a heat exchanger; wherein the platform is configured for bearing the temperature control target;
the thermo electric cooler is located between the platform and the heat exchanger and configured for heating or refrigerating the temperature control target;
the heat exchanger is configured for exchanging heat with the thermo electric cooler.

34. The method according to claim 33, wherein a temperature sensor is arranged in the platform, and the temperature control system acquires the temperature of the temperature control target through the temperature sensor.

35. The method according to claim 33, wherein the cooling assembly comprises a heat sink and a pump;
wherein the heat sink is configured for dissipating heat from a liquid passing through the heat exchanger;
the pump is configured for enabling the liquid thermally dissipated by the heat sink to enter the heat exchanger again.

36. The method according to claim 35, wherein the cooling assembly further comprises a liquid reservoir communicating with the pump and the heat sink and configured for storing a liquid.

37. The method according to claim 36, wherein the temperature control system further comprises a detector located between the pump and the heat exchanger and configured for acquiring the liquid pressure in the cooling assembly.

38. A temperature control system, comprising the cooling assembly and the temperature control assembly according to claim 21, wherein the cooling assembly performs liquid-based heat dissipation on the temperature control assembly.

39. A computer device, comprising a memory and a processor, wherein the processor is configured for executing a computer program stored in the memory to implement the method according to claim 21.

40. A non-volatile computer-readable storage medium storing a computer program, wherein the computer program, when executed by one or more processors, causes the processor to implement the method according to claim 21.
